(19) United States
(12) Patent Application Publication
(10) Pub. No.: US 2021/0160241 A1
(43) Pub. Date: May 27, 2021

(54) System And Method For Identification Of Information Assets

(71) Applicant: Positive Technologies, Moscow (RU)

(72) Inventors: Aleksej Vyacheslavovich Andreev, Moscow (RU); Vadim Sergeevich Dikke, Tomsk (RU); Kirill Sergeevich Ivanov, British Columbia (CA); Yurij Vladimirovich Maksimov, Fryazino (RU); Mikhail Borisovich Pomzov, Moscow (RU)

(21) Appl. No.: 16/690,616

(22) Filed: Nov. 21, 2019

(51) Int. Cl. H04L 29/06; G06F 9/4401; G06F 9/455; H04L 12/24

(52) U.S. Cl. CPC H04L 63/102; G06F 9/4406; G06F 9/45558; H04L 63/0236; H04L 41/12; H04L 63/126; H04L 63/0876; H04L 63/062; H04L 41/0893; H04L 63/0272

(57) ABSTRACT

A method of asset identification includes comparing identification data of an incoming asset to identification data of all existing assets by a pairwise comparison of identification data and at least one method of checking identification data to obtain a set of existing assets that match the incoming asset; checking the set of existing assets for consistency based on the asset type and the method of checking identification data to produce a consistent subset of assets identical to the incoming asset; if a number of existing assets is equal to zero, a new entry is created according to the incoming data; if the number of existing assets is equal to one, the matching existing asset is updated according to the incoming data; and if the number of existing assets is greater than one, the matching existing assets are united and the united entry is updated according to the incoming data.

### FIELD OF THE INVENTION

The invention relates to solutions for information asset management in security information and event management systems, and methods of identifying information assets in particular.

### BACKGROUND OF THE INVENTION

Currently, the number of information systems (such as operating systems of network devices), technologies, and protocols used to ensure information security is growing. Security information and event management systems (“SIEM”) are widely known and implemented to catch abnormal behavior or potential cyberattacks within a company's IT infrastructure. A typical SIEM operates by aggregating and analyzing activity from many difference resources across the entire IT infrastructure to detect and report security incidents. The range of tasks facing a modern SIEM is very wide: they include data aggregation from various sources, event correlation and incident management, device configuration auditing for compliance with security policies, vulnerability monitoring, and risk assessment.

A key condition ensuring the effective use of these functions in information security management is the maintenance of an up-to-date, accurate, and consistent database of information assets based on a number of heterogeneous sources that in a general case provide an incomplete and potentially inconsistent set of data that identifies assets. In the context of SIEMs, information asset (hereinafter referred to as the asset) is an entry in the database corresponding to a real information system (hereinafter the IS), which is a combination of physical and virtual devices (server, computer, network equipment) connected to the information network, as well as the installed software, including operating system. It should be noted that such definition of information asset is specific to SIEMs and may differ from other possible interpretations of the term in other contexts. It is further noted that the very problem of asset identification as described below in detail is specific to SIEMs, both because of the variety of sources of information about assets and the range of tasks dependent on the accurate state of asset database, which are typical in a modern SIEM.

Database updates involve comparing a set of identifying attributes in incoming data to the existing state of the asset database. Incoming data includes description of the IS state at a given time. This information may vary in content and completeness, depending on how it was collected (detailed scanning of the device, collecting network traffic of the device, reading various events from files related to the device, etc.). The SIEM component that ensures updating asset database using incoming data can be called differently depending on a particular system, For example, the QRadar Vulnerability Manager by IBM (https://www.ibm.com/support/knowledgecenter/SS42VS_7.2.8/com.ibm.qrad ar.doc/c_qradar_adm_asset_workflow.html) calls this component asset profiler, as according to the system's terminology, entry in the asset database is called asset profile. Since there is no fixed terminology, the system component that ensures updating asset database will be referred to as “asset aggregator.” In existing solutions, the same component also performs asset identification.

Asset database updates may lead to three possible scenarios, according to the result of the incoming asset identification. If no assets are found that match the new data, a new asset is usually created based on the new data. If the new data matches only one existing asset, information on this asset is usually updated. If the new data matches more than one existing asset, the system behavior depends on its specific implementation. One of the particular solutions in the latter case is uniting all found assets into one and updating the database on the basis of the incoming data.

There are several factors that complicate this task: incomplete sources of data, the dynamic nature of some identifying attributes, and intermediary devices on network routes between data collection agents and the target IS, capable of changing attributes that identify an asset. An overwhelming majority of sources provide fundamentally incomplete sets of data. The most complete set of identifying attributes can only be obtained through auditing target IS in white-box mode (collecting all the key information on the device by running the collection tools while being directly connected to the device's OS using privileged account), but even in this case, the completeness of data depends on the combination of the device operating system and the protocol used for auditing (for example, SSH, WMI, SNMP, OPSEC). Some identifying attributes can change over time, either automatically, within the normal functioning of the IS (for example, the IP address), or as a result of the administrator's actions (for example, the host name). Finally, intermediary devices can change the attributes that could potentially identify the asset either between the scanning agent and the target IS (NAT, load balancers), or between the event source and the event destination (for example, a syslog centralized server), or between the IS and the event source from which information about the IS considered as an asset is received (for example, a VPN gateway between a remote device and a DHCP server).

This may inevitably lead to situations when some identifying attributes in the incoming data match one or more existing entries in the asset database, but in reality, the incoming data and existing entries refer to different ISs. There are two principal approaches to such situations. The first one can be called the presumption of asset equality: it is assumed that in most cases, the assets some of whose attributes are found to match are really identical, unless there are clear signs of the reverse. The second one can be called the presumption of difference: it is assumed that the assets are different if, as a result of additional checks, it is not possible to establish their equality. Currently, the existing solutions are dominated by the first approach. We will base both the problem statement and the terminology on the second approach. Within this approach, the hypothesis that two assets are different is considered normal, while the hypothesis that they are identical is considered alternative. Accordingly, considering two different assets that correspond to different ISs identical will be a type 1 error; considering two different entries as matching two different ISs while in reality they match the same IS will be a type 2 error.

The task, therefore, is to minimize the number of type 1 errors. A secondary goal is to minimize the number of type 2 errors. Tolerance to type 2 errors is due to the fact that their main cause is incomplete incoming data; accordingly, as more data identifying assets is collected, most type 2 errors are automatically corrected. Type 1 errors that result in uniting assets are on the contrary destructive as the result can only be corrected manually. Therefore, the introduction of any logic in order to minimize the number of type 2 errors is only permissible if this does not lead to an increase in the number of type 1 errors.

The existing methods of asset identification allow a high frequency of type 1 errors and employ rudimentary mechanisms to check for them. As a result, entries appear in the asset storage with data corresponding to several different ISs mixed in a chaotic and unpredictable way. These entries cannot be used for efficient performance of any tasks of a modern SIEM involving the asset management component, be it assessment of compliance with the security policy, assessment of risks, or associating events and incidents with assets. To restore a coherent state of the asset storage, such entries must be deleted manually, which leads to losing all the data related to the affected assets. Moreover, there is no guarantee that such entries will not reappear during the system operation afterwards. In some cases, for example in a method for asset identification implemented by IBM in QRadar Vulnerability Manager (www.ibm.com/support/knowledgecenter/SS42VS_7.2.8/com.ibm.qradar.doc/c_qradar_ug_assets.html), additional a posteriori checks are introduced in which an anomalous number of asset unions is an indirect sign of type 1 errors. Thus, the existing methods do not solve the problem of minimizing false assets unions. The proposed method allows solving this problem.

### SUMMARY OF THE INVENTION

The technical result of the invention is to provide an asset identification method implemented by a software means involved in processing incoming data related to real ISs and delivering verdicts on whether it is needed to unite the assets, update entries in the asset database, or create new entries. The method helps to minimize type 1 errors, namely, the number of unions of entries corresponding to different real ISs in the asset database.

This asset identification method allows to consecutively check identification data arranged by priority according to the type of both compared assets and supporting checks, in order to eliminate the possibility of uniting the assets that do not correspond to the priority criteria, based on the correspondence of the identification data that were given less priority during the supporting checks.

According to one of the particular implementations, a method of identifying assets is proposed, including the steps of:
comparing a set of identification data of an incoming asset to identification data of all existing assets by a pairwise comparison of identification data of the incoming asset to each existing asset entry based on an asset type, which is further defined below, and at least one method of checking identification data to obtain a set of existing assets that match the incoming asset;
checking the set of existing assets that match the incoming asset for consistency based on the asset type and at least one method of checking identification data to produce a consistent subset of assets identical to the incoming asset;
if a number of existing assets identical to the incoming asset is equal to zero, a new entry is created in an asset database according to the incoming data;
if the number of existing assets identical to the incoming asset is equal to one, the matching existing asset is updated in the asset database according to the incoming data; and
if the number of existing assets identical to the incoming asset is greater than one, the matching existing assets are united and the united entry is updated according to the incoming data.

According to one of the particular implementations, a method is proposed wherein the asset type is determined based on a type of the operating system where different types of operating systems are organized in an inheritance hierarchy, with more detailed information about the operating system being placed lower in the inheritance hierarchy relative to more general information, such that at the root of the inheritance hierarchy is a device type with an operating system that nothing is known about, wherein, if asset types are not on the same branch in the inheritance hierarchy, it is a mismatch criterion for the two assets. In this case, the two compared assets cannot be united even if other identification data match.

According to one of the particular implementations, a method is proposed wherein the identification data is checked by comparing identification keys arranged by priority according to a type of both compared assets and a result of the supporting checks.

According to one of the particular implementations, a method is proposed wherein the identification keys comprise at least one of the following: a virtual machine identifier, which can be obtained by querying hypervisor software about managed virtual machines; a set of MAC addresses of all active device interfaces; a host name as configured locally on the device; a unique device identifier; a fully qualified domain name of the device, which consists of a host name and a domain suffix (for example, host1.example.com where host1 is the host name); a set of internet protocol version 4 network addresses of all active device interfaces; a set of internet protocol version 6 network addresses of all active device interfaces; and a set of unique identifiers of devices included in a failover group, which is used to represent a failover group as a single asset regardless of whatever device is currently in the active state in the group.

According to another particular implementation, a method is proposed wherein for operating systems of network devices, the unique device identifier comprises a serial number, and wherein for Unix and Windows operating system families, the unique device identifier comprises a unique identifier of a disk boot partition.

According to another particular implementation, a method is proposed wherein, where a virtual machine identifier for each of the assets being compared is specified, equality of the virtual machine identifiers is a matching criterion for the two compared assets and inequality of the virtual machine identifiers is a mismatch criterion for the two compared assets, in which case the two compared assets cannot be united even if other identification keys match.

According to another particular implementation, a method is proposed wherein when comparing two assets, if at least one of them does not have a virtual machine identifier specified, the comparison criterion is selected depending on results of an additional check that determines whether both assets correspond to virtual devices.

According to another particular implementation, a method is proposed wherein, where the two compared assets correspond to virtual devices, and each of the compared assets has a non-empty set of MAC addresses specified, an absence of intersection of MAC address sets of the compared assets is a mismatch criterion for the compared assets, in which case the two compared assets cannot be united even if other identification keys match.

According to another particular implementation, a method is proposed wherein, where the two compared assets correspond to virtual devices and at least one of them has an empty set of MAC addresses, the comparison criterion is selected depending on results of an additional check that determines whether both assets correspond to Microsoft Windows, Cisco IOS, or VMWare ESXi devices, and have their fully qualified domain names specified.

According to another particular implementation, a method is proposed wherein, if both compared assets correspond to Microsoft Windows, Cisco 10S, or VMWare ESXi devices, and have their fully qualified domain names specified, equality of fully qualified domain names is a matching criterion and inequality of fully qualified domain names is a mismatch criterion for the two compared assets, in which case the two compared assets cannot be united even if other identification keys match

According to another particular implementation, a method is proposed wherein, if any of the assets being compared does not correspond to a Microsoft Windows, Cisco IOS, or VMWare ESXi device, or does not have a fully qualified domain name specified, equality of host names of the two compared assets is a matching criterion, and inequality of host names or absence of a host name of any of the assets being compared is a mismatch criterion for the two compared assets, in which case the two compared assets cannot be united even if other identification keys match.

According to another particular implementation, a method is proposed wherein, where the two compared assets correspond to virtual devices, MAC address sets of the compared assets intersect, and a unique device identifier for each of the assets being compared is specified, equality of the unique device identifiers is a matching criterion for the two compared assets.

According to another particular implementation, a method is proposed wherein, where the two compared assets correspond to virtual devices, and MAC address sets of the compared assets intersect, if at least one of them does not have a unique device identifier specified, equality of host names of the two compared assets or absence of a host name of any of the assets being compared is a matching criterion and inequality of the host names is a mismatch criterion, in which case the two compared assets cannot be united even if other identification keys match.

According to another particular implementation, a method is proposed wherein, where at least one of the compared assets is not known to correspond to a virtual device, the equality of unique device identifiers of the compared assets can be considered a matching criterion for two assets.

According to another particular implementation, a method is proposed wherein, where at least one of the compared assets is not known to correspond to a virtual device, if both of the compared assets have unique device identifiers specified and these identifiers are not equal, the comparison criterion is selected depending on results of an additional check that determines whether both compared assets correspond to Cisco ASA devices.

According to another particular implementation, a method is proposed wherein, if at least one of the two compared assets is not a Cisco ASA device, it is a mismatch criterion for the two compared assets, in which case the compared assets cannot be united even if other identification keys match.

According to another particular implementation, a method is proposed wherein inequality of host names of the compared assets is a mismatch criterion for the two compared assets, both of which correspond to Cisco ASA devices, in which case the compared assets cannot be united even if other identification keys match.

According to another particular implementation, a method is proposed wherein both of the compared assets correspond to Cisco ASA devices, and wherein, if host names of the compared assets match, a comparison criterion is selected depending on results of an additional check that determines whether both compared assets are known as members of a failover group,

According to another particular implementation, a method is proposed wherein, where the compared assets are both members of a failover group, equality of sets of unique identifiers of devices included in the failover group for the compared assets is a matching criterion for the two compared assets and inequality of the sets of unique identifiers of devices included in the failover group is a mismatch criterion for the two compared assets, in which case the compared assets cannot be united even if other identification keys match,

According to another particular implementation, a method is proposed wherein, where one of the compared assets is known as a member of a failover group, inclusion of a unique device identifier of one of the compared assets in the other compared assets set of unique identifiers is a matching criterion for the two compared assets and absence of the unique device identifier of one of the compared assets from the other compared asset's set of unique identifiers is a mismatch criterion for the two compared assets, in which case the compared assets cannot be united even if other identification keys match.

According to another particular implementation, a method is proposed wherein, where both of compared assets are not known as members of a failover group and a comparison is made for internet protocol version 4 and internet protocol version 6 addresses, complete inclusion of a set of IP addresses of one of the compared assets in a set of IP addresses of the other compared asset is a matching criterion for the two compared assets and absence of complete inclusion of the set of IP addresses of one of the compared assets in the set of IP addresses of the other compared asset is a mismatch criterion for the two compared assets, in which case the compared assets cannot be united even if other identification keys match.

According to another particular implementation, a method is proposed wherein at least one of the compared assets is not known to correspond to a virtual device and at least one of the compared assets does not have a unique device identifier specified, priority of identification keys for further comparison is set depending on results of an additional check of the type of the assets being compared.

According to another particular implementation, a method is proposed wherein the affiliation of both compared assets with one and the same type based on the operating system of the assets identified as Microsoft Windows, VMware ESXi, or Cisco IOS, can be considered a ground for selecting the fully qualified domain name as the priority key.

According to another particular implementation, a method is proposed wherein, where the fully qualified domain name is selected as a priority key and the fully qualified domain name is specified for both compared assets, equality of the fully qualified domain names is a matching criterion for the two compared assets and inequality of the fully qualified domain names is a mismatch criterion for the two compared assets, in which case the compared assets cannot be united even if other identification keys match.

According to another particular implementation, a method is proposed wherein, where the fully qualified domain name is selected as a priority key and at least one of the compared assets does not have the fully qualified domain name specified, while the operating system of both compared assets is identified as Cisco IOS and host names are specified for both compared assets, equality of the host names is a matching criterion for the two compared assets and inequality of the host names is a mismatch criterion for the two compared assets, in which case the compared assets cannot be united even if other identification keys match.

According to another particular implementation, a method is proposed wherein, where host names for the compared assets are specified and the fully qualified domain name is not selected as a priority key, equality of the host names is a matching criterion for the two compared assets and inequality of the host names is a mismatch criterion for the two compared assets, in which case the compared assets cannot be united even if other identification keys match

According to another particular implementation, a method is proposed wherein, where each of the compared assets has a non-empty set of MAC addresses specified, intersection of the MAC address sets is a matching criterion for the two compared assets and absence of intersection of the MAC address sets is a mismatch criterion for the two compared assets, in which case the two assets cannot be united even if other identification keys match.

According to another particular implementation, a method is proposed wherein where at least one of the compared assets has an empty set of MAC addresses, a comparison criterion is selected depending on a presence of a non-empty set of internet protocol version 4 addresses in keys of both compared assets.

According to another particular implementation, a method is proposed wherein, where each of the compared assets has a non-empty set of internet protocol version 4 addresses, intersection of the internet protocol version 4 address sets is a matching criterion for the two compared assets and absence of intersection of the internet protocol version 4 address sets is a mismatch criterion for the two compared assets.

According to another particular implementation, a method is proposed wherein, where a set of internet protocol version 4 addresses of at least one of the compared assets is empty, intersection of the internet protocol version 6 address sets is a matching criterion for the two compared assets and absence of intersection of the internet protocol version 6 address sets is a mismatch criterion for the two compared assets.

According to another particular implementation, a method is proposed wherein the step of producing the consistent subset of assets identical to the incoming asset comprises;
ordering the set of assets matching the incoming asset in reverse chronological order in accordance with time of a last update of the asset entry;
creating a common set of identification data and adding the identification data of the incoming asset to it;
setting a set of assets that are identical to the incoming asset as an empty set;
sequentially checking each entry from the ordered set of assets matching the incoming asset for compliance with the common set of identification data based on the same methods of checking the asset type and identification data that are used to determine the matching of the incoming asset to existing entries in the same logical order; and
if the entry being checked matches the common set of identification data, this entry is included in a set of assets identical to the incoming asset, and its set of identification data is added to the common set of identification data.

According to another particular implementation, a method is proposed wherein a set of identification data of all existing assets can be obtained not by querying the asset database but by saving identification data of all incoming assets and decisions to update or unite the assets.

### BRIEF DESCRIPTION OF THE DRAWINGS

Further goals, attributes, and advantages of the invention will be apparent from the following description of the invention with references to the accompanying drawings in which:

FIG. 1 describes a variant of interaction of the components of a SIEM, known from prior art.

FIG. 2 describes a variant of interaction of the components of a SIEM, within which the invention can be implemented.

FIG. 3 illustrates the operation mode of the invention.

### DETAILED DESCRIPTION OF THE INVENTION

The goals and attributes of the invention, methods for achieving these goals and attributes will become evident by referencing proposed implementation variants. However, the invention is not limited to the proposed implementation variants detailed below, it can be implemented in various forms. The essence provided in the description just gives specific details necessary to help a technical specialist understand the invention completely, and the invention is defined within the scope of the appended patent claim.

Event management service is a central component of a SIEM, which ensures analysis, normalization, and correlation of incoming events, as well as retrieving useful data, including those related to assets. This component, as well as its internal architecture, may be called differently depending on particular system and vendor. For example, the QRadar Vulnerability Manager by IBM calls it Sense Analytics Engine (https://public.dhe.ibm.com/common/ssi/ecm/wg/en/wgd03097usen/qradar-siem-digital-data-sheet-june-29-2016_WGD03097USEN.pdf). In the present invention, this component of a SIEM is considered exclusively in terms of its interfacing with the components directly related to the nature of invention, namely, with the asset management components of a SIEM.

Scan management service is a SIEM component that transfers information about IS from the built-in or external auditing and vulnerability monitoring scanners to the system, if it is implemented in the system. The name of the component and its availability in the system depend on a particular system and vendor. For example, the QRadar Vulnerability Manager by IBM calls it Vulnerability Manager (https://www.ibm.com/suppor/knowledgecenter/SS42VS_7.2.8/com.ibm.qrad ar.doc/c_qvm_vm_ov.html)

Scan is an asset format in which information of the IS state at a given time is transferred to the system from the scan management service.

Scan storage is a system component which can be used for intermediary consolidation of scans and subsequent transfer of these scans to the asset aggregator for processing.

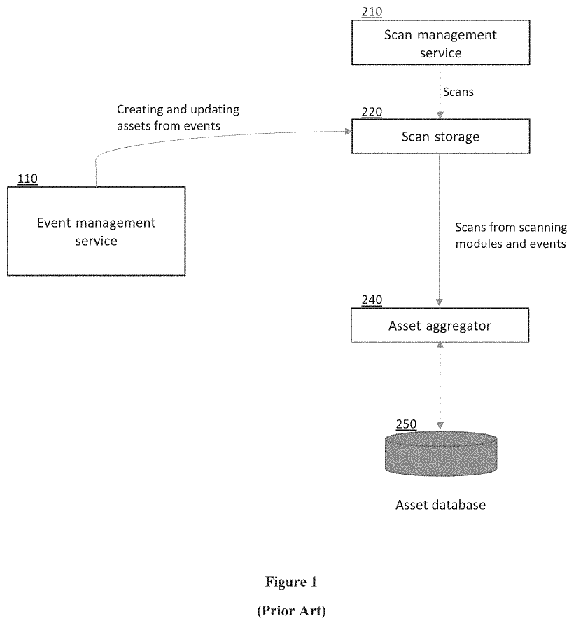

FIG. 1 describes a variant of interaction of the components of a SIEM. Since the invention is used in asset management, the diagram shows only the components of the system directly related to the task of maintaining and updating the asset database and the components that interact with them, while, for the sake of simplicity, all components related to event management are represented as a single component, namely an event management service 110, regardless of the internal architecture of a specific solution of the component that does not affect its interfacing with the asset management components.

The scan management service 210 delivers scans collected by scanning modules (not shown in the diagram) to the scan storage 220. Data on assets received from the scan management service 110 is also delivered to the scan storage 220 in the form of IS scans. The asset aggregator 240 receives new scans from the scan storage 220, searches in the asset database 250 for entries that correspond to the incoming scan by the equality of at least one of the key fields, and, based on the search results, creates a new entry, updates the existing one, or unites several existing entries in the asset database 250.

However, as it was mentioned in the background section above, this solution may lead to a high frequency of type 1 errors that consist in uniting the entries corresponding to different real ISs.

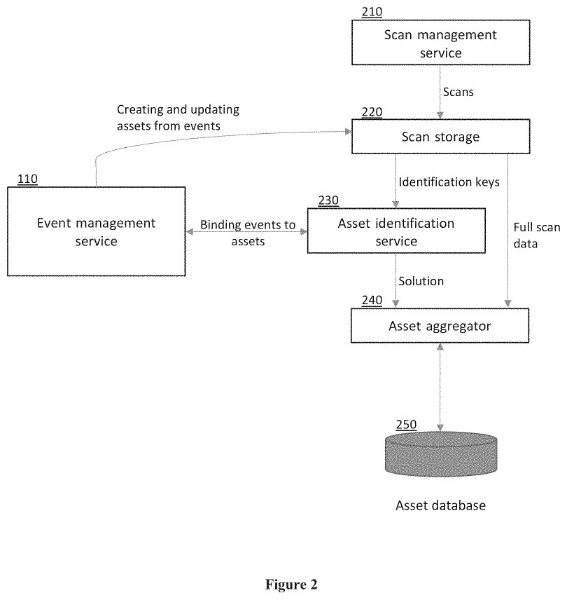

FIG. 2 describes a variant of interaction of the components of a SIEM in accordance with the present invention. Unlike FIG. 1, this diagram contains the asset identification service 230, which receives the type and set of identification keys of each incoming asset from the scan storage 220, determines the set of existing assets identical to the incoming asset, and depending on cardinality, decides whether to create a new asset, update an existing asset, or unite several existing assets. The asset aggregator 240 receives a command from the asset identification service 230 according to the decision taken, receives a scan of the incoming asset from the scan storage 220, executes the received command on entries in the asset database 250 and the scan data, and writes the result to the asset database 250.

Since identification data of all assets necessarily passes through the asset identification service 230 before being written to the asset database 250, in a particular implementation the set of identification data of all existing assets can be obtained without a direct request from the asset identification service 230 to the asset database 250, by retaining identification data of all incoming assets and the decisions to update or unite the assets.

In one of the implementation variants, the asset identification service 230 also responds to requests from the event management service 110 to establish an association between assets and events (binding events to assets). This additional function does not affect the state of the asset database 250.

Asset identification service can be implemented both as a separate service in the operating system and as a software component as part of the asset aggregator.

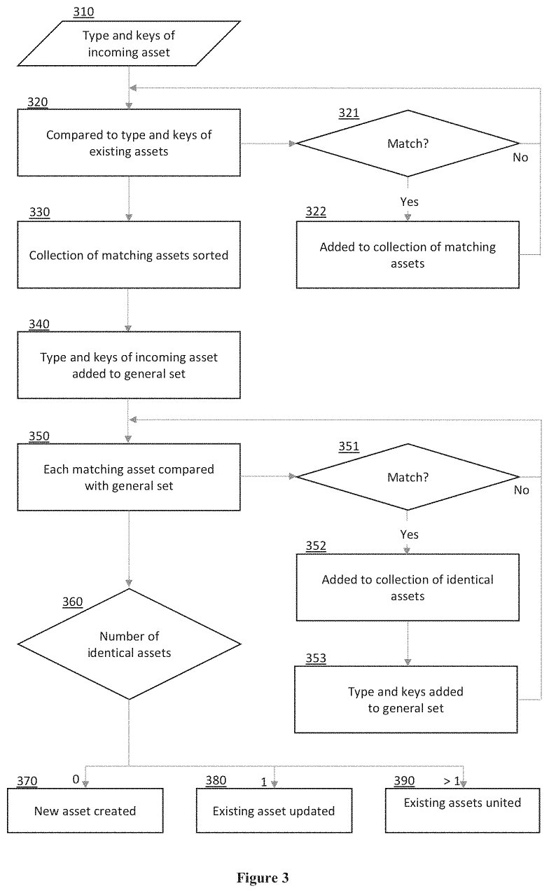

FIG. 3 illustrates the operation mode of the invention. The type and identification keys of the incoming asset 310 are delivered to the asset identification service 230. During stage 320, a set of identification data of the incoming asset 310 is compared to the set of identification data of all existing assets by pairwise comparison of identification data of the incoming asset to identification data of each existing entry based on the asset type and at least one method of checking identification data. If during the verification stage 321, the existing asset is found to match the incoming asset, during stage 322 the existing asset is added to the collection of assets matching the incoming asset, while the collection of assets is hereinafter understood as a set of identification data, with the type of assets indicated. The comparison of the incoming asset 310 and existing assets is performed until the set of identification data for all existing assets is exhausted. During stage 330, the resulting collection of assets matching the incoming asset is ordered in reverse chronological order in accordance with the time of the last update of the asset. During stage 340, a common set of identification data is created and the identification data of the incoming asset is added to it. During stage 350, each asset from the ordered collection of assets matching the incoming asset is sequentially checked for compliance with the common set based on the same methods of checking the asset type and identification data that are used to determine the matching of the incoming asset to existing entries in the same logical order. If during the verification stage 351, the asset being checked is found to match the common set, during stage 352 the asset is added to the collection of assets identical to the incoming asset, and during stage 353 the identification data of the asset is added to the common set.

During stage 360, a decision is taken based on the number of assets that are identical to the incoming asset. If the number is equal to zero, a new asset is created during stage 370. If the number is equal to one, the existing asset is updated during stage 380. If the number is greater than one, the existing assets are united and the united asset is updated based on data of the incoming asset during stage 390.

Examples provided in the description do not limit the scope of the invention defined by the patent claim. It will be clear to a specialist in this field that other implementations of the invention can exist that are consistent with the nature and scope of the invention.

What is claimed is:

1. A method of asset identification comprising the steps of:
comparing a set of identification data of an incoming asset to identification data of all existing assets by a pairwise comparison of identification data of the incoming asset to each existing asset entry based on an asset type and at least one method of checking identification data to obtain a set of existing assets that match the incoming asset;
checking the set of existing assets that match the incoming asset for consistency based on the asset type and the at least one method of checking identification data to produce a consistent subset of assets identical to the incoming asset;
if a number of existing assets identical to the incoming asset is equal to zero, a new entry is created in an asset database according to the incoming data;
if the number of existing assets identical to the incoming asset is equal to one, the matching existing asset is updated in the asset database according to the incoming data; and
if the number of existing assets identical to the incoming asset is greater than one, the matching existing assets are united and the united entry is updated according to the incoming data.

2. A method of claim 1, wherein the asset type is determined based on a type of an operating system, where different types of operating systems are organized in an inheritance hierarchy, with more detailed information about the operating system being placed lower in the inheritance hierarchy relative to more general information, such that at a root of the inheritance hierarchy is a device type with an operating system that nothing is known about, wherein, if asset types are not on the same branch in the inheritance hierarchy, it is a mismatch criterion for the two compared assets, in which case the two compared assets cannot be united even if other identification data match.

3. The method of claim 1, wherein the identification data is checked by comparing identification keys arranged by priority according to a type of both compared assets and a result of the supporting checks.

4. The method of claim 3, wherein the identification keys comprise at least one of the following: a virtual machine identifier, a set of MAC addresses of all active device interfaces, a host name, a unique device identifier, a fully qualified domain name of the device, a set of internet protocol version 4 network addresses of all active device interfaces, a set of internet protocol version 6 network addresses of all active device interfaces, and a set of unique identifiers of devices included in a failover group.

5. The method of claim 4, wherein for operating systems of network devices, the unique device identifier comprises a serial number, and wherein for Unix and Windows operating system families, the unique device identifier comprises a unique identifier of a disk boot partition.

6. The method of claim 3, wherein, where a virtual machine identifier for each of the assets being compared is specified, equality of the virtual machine identifiers is a matching criterion for the two compared assets and inequality of the virtual machine identifiers is a mismatch criterion for the two compared assets, in which case the two compared assets cannot be united even if other identification keys match.

7. The method of claim 3, wherein when comparing two assets, if at least one of them does not have a virtual machine identifier specified, the comparison criterion is selected depending on results of an additional check that determines whether both assets correspond to virtual devices.

8. The method of claim 7, wherein, where the two compared assets correspond to virtual devices, and each of the compared assets has a non-empty set of MAC addresses specified, an absence of intersection of MAC address sets of the compared assets is a mismatch criterion for the compared assets, in which case the two compared assets cannot be united even if other identification keys match.

9. The method of claim 7, wherein, where the two compared assets correspond to virtual devices and at least one of the two compared assets has an empty set of MAC addresses, the comparison criterion is selected depending on results of an additional check that determines whether both assets correspond to Microsoft Windows, Cisco IOS, or VMWare ESXi devices, and have their fully qualified domain names specified.

10. The method of claim 9, wherein, if both compared assets correspond to Microsoft Windows, Cisco IOS, or VMWare ESXi devices, and have their fully qualified domain names specified, equality of fully qualified domain names is a matching criterion and inequality of fully qualified domain names is a mismatch criterion for the two compared assets, in which case the two compared assets cannot be united even if other identification keys match.

11. The method of claim 9, wherein, if any of the assets being compared does not correspond to a Microsoft Windows, Cisco IOS, or VMWare ESXi device, or does not have a fully qualified domain name specified, equality of host names of the two compared assets is a matching criterion, and inequality of host names or absence of a host name of any of the assets being compared is a mismatch criterion for the two compared assets, in which case the two compared assets cannot be united even if other identification keys match.

12. The method of claim 7, wherein, where the two compared assets correspond to virtual devices, MAC address sets of the compared assets intersect, and a unique device identifier for each of the assets being compared is specified, equality of the unique device identifiers is a matching criterion for the two compared assets.

13. The method of claim 7, wherein, where the two compared assets correspond to virtual devices, and MAC address sets of the compared assets intersect, if at least one of them does not have a unique device identifier specified, equality of host names of the two compared assets or absence of a host name of any of the assets being compared is a matching criterion and inequality of the host names is a mismatch criterion, in which case the two compared assets cannot be united even if other identification keys match.

14. The method of claim 7, wherein, where at least one of the compared assets is not known to correspond to a virtual device, the equality of unique device identifiers of the compared assets can be considered a matching criterion for two assets.

15. The method of claim 7, wherein, where at least one of the compared assets is not known to correspond to a virtual device, if both of the compared assets have unique device identifiers specified and these identifiers are not equal, the comparison criterion is selected depending on results of an additional check that determines whether both compared assets correspond to Cisco ASA devices.

16. The method of claim 15, wherein, if at least one of the two compared assets is not a Cisco ASA device, it is a mismatch criterion for the two compared assets, in which case the compared assets cannot be united even if other identification keys match.

17. The method of claim 15, wherein inequality of host names of the compared assets is a mismatch criterion for the two compared assets, both of which correspond to Cisco ASA devices, in which case the compared assets cannot be united even if other identification keys match.

18. The method of claim 15, wherein both of the compared assets correspond to Cisco ASA devices, and wherein, if host names of the compared assets match, a comparison criterion is selected depending on results of an additional check that determines whether both compared assets are known as members of a failover group.

19. The method of claim 18, wherein, where the compared assets are both members of a failover group, equality of sets of unique identifiers of devices included in the failover group for the compared assets is a matching criterion for the two compared assets and inequality of the sets of unique identifiers of devices included in the failover group is a mismatch criterion for the two compared assets, in which case the compared assets cannot be united even if other identification keys match.

20. The method of claim 18, wherein, where one of the compared assets is known as a member of a failover group, inclusion of a unique device identifier of one of the compared assets in the other compared asset's set of unique identifiers is a matching criterion for the two compared assets and absence of the unique device identifier of one of the compared assets from the other compared asset's set of unique identifiers is a mismatch criterion for the two compared assets, in which case the compared assets cannot be united even if other identification keys match.

21. The method of claim 18, wherein, where both of compared assets are not known as members of a failover group and a comparison is made for internet protocol version 4 and internet protocol version 6 addresses, complete inclusion of a set of IP addresses of one of the compared assets in a set of IP addresses of the other compared asset is a matching criterion for the two compared assets and absence of complete inclusion of the set of IP addresses of one of the compared assets in the set of IP addresses of the other compared asset is a mismatch criterion for the two compared assets, in which case the compared assets cannot be united even if other identification keys match.

22. The method of claim 7, wherein at least one of the compared assets is not known to correspond to a virtual device and at least one of the compared assets does not have a unique device identifier specified, priority of identification keys for further comparison is set depending on results of an additional check of the type of the assets being compared.

23. The method of claim 22, wherein affiliation of both of the compared assets with the same type based on an operating system of the assets identified as Microsoft Windows, VMware ESXi, or Cisco IOS is considered a ground for selecting the fully qualified domain name as a priority key.

24. The method of claim 23, wherein, where the fully qualified domain name is selected as a priority key and the fully qualified domain name is specified for both compared assets, equality of the fully qualified domain names is a matching criterion for the two compared assets and inequality of the fully qualified domain names is a mismatch criterion for the two compared assets, in which case the compared assets cannot be united even if other identification keys match.

25. The method of claim 23, wherein, where the fully qualified domain name is selected as a priority key and at least one of the compared assets does not have the fully qualified domain name specified, while the operating system of both compared assets is identified as Cisco IOS and host names are specified for both compared assets, equality of the host names is a matching criterion for the two compared assets and inequality of the host names is a mismatch criterion for the two compared assets, in which case the compared assets cannot be united even if other identification keys match.

26. The method of claim 23, wherein, where host names for the compared assets are specified and the fully qualified domain name is not selected as a priority key, equality of the host names is a matching criterion for the two compared assets and inequality of the host names is a mismatch criterion for the two compared assets, in which case the compared assets cannot be united even if other identification keys match.

27. The method of claim 22, where at least one of the compared assets does not have a host name specified and where each of the compared assets has a non-empty set of MAC addresses specified, intersection of the MAC address sets is a matching criterion for the two compared assets and absence of intersection of the MAC address sets is a mismatch criterion for the two compared assets, in which case the two assets cannot be united even if other identification keys match.

28. The method of claim 22, where at least one of the compared assets does not have a host name specified and where at least one of the compared assets has an empty set of MAC addresses, a comparison criterion is selected depending on a presence of a non-empty set of internet protocol version 4 addresses in keys of both compared assets.

29. The method of claim 28, wherein, where each of the compared assets has a non-empty set of internet protocol version 4 addresses, intersection of the internet protocol version 4 address sets is a matching criterion for the two compared assets and absence of intersection of the internet protocol version 4 address sets is a mismatch criterion for the two compared assets.

30. The method of claim 28, wherein, where a set of internet protocol version 4 addresses of at least one of the compared assets is empty, intersection of the internet protocol version 6 address sets is a matching criterion for the two compared assets and absence of intersection of the internet protocol version 6 address sets is a mismatch criterion for the two compared assets.

31. The method of claim 1, wherein the step of producing the consistent subset of assets identical to the incoming asset comprises:
ordering the set of assets matching the incoming asset in reverse chronological order in accordance with time of a last update of the asset entry;
creating a common set of identification data and adding the identification data of the incoming asset to it;
setting a set of assets that are identical to the incoming asset as an empty set;
sequentially checking each entry from the ordered set of assets matching the incoming asset for compliance with the common set of identification data based on the same methods of checking the asset type and identification data that are used to determine the matching of the incoming asset to existing entries in the same logical order; and
if the entry being checked matches the common set of identification data, this entry is included in a set of assets identical to the incoming asset, and its set of identification data is added to the common set of identification data.

32. The method of claim 1, wherein a set of identification data of all existing assets is obtained not by querying the asset database but by saving identification data of all incoming assets and decisions to update or unite the assets.
